(19) United States
(12) Patent Application Publication
(10) Pub. No.: US 2026/0209548 A1
(43) Pub. Date: Jul. 23, 2026

(54) RELEASE COATING COMPOSITION

(71) Applicant: WACKER CHEMIE AG, Munich (DE)

(72) Inventors: Timothy RUMMEL, Ann Arbor, MI (US); Joel Kennard, Ann Arbor, MI (US); Christine Klingler, Ann Arbor, MI (US); Keith Stowell, Ann Arbor, MI (US)

(73) Assignee: WACKER CHEMIE AG, Munich (DE)

(21) Appl. No.: 19/140,394

(22) PCT Filed: Dec. 20, 2022
(86) PCT No.: PCT/EP2022/087137

§ 371 Date: Jun. 18, 2025

(51) Int. Cl. C09D 183/04; C09J 7/40

(52) U.S. Cl. CPC C09D 183/04; C09J 7/401; C09J 2203/334; C09J 2483/005

(57) ABSTRACT

A release coating composition includes an organosilicon compound having at least one terminal aliphatically unsaturated group and an organosilicon composition. The organosilicon compound exhibits a viscosity of 150 cPs or less. The organosilicon composition exhibits a viscosity that is at least one hundred times the viscosity of the organosilicon compound. The release coating composition also includes an organosilicon crosslinker having at least one Si-bonded hydrogen atom and a catalyst, which promotes the addition of the at least one Si-bonded hydrogen atom to the at least one aliphatically unsaturated group. One or more inhibitors are also included to retard the addition of the at least one Si-bonded hydrogen atom to the at least one aliphatically unsaturated group when the composition is at room temperature. Before curing, the release coating composition exhibits a viscosity of 150-800 cPs at 25° C. and the release coating composition cures at temperatures of 80° C. or less.

### BACKGROUND

The invention relates to a release coating composition and uses of the same.

Thermally responsive record materials are known and often utilized for labels that require test, bar code imaging, graphics, and similar image information. In order to be acceptable for use, such labels require high print contrast and sharp and unbroken imaging. Thermally responsive record materials often include heat sensitive imaging coatings requiring color forming compositions that are utilized to form images. Such color forming compositions typically are activated at temperatures of 80° C. or more. Such labels can be created at a point of use and application by printer equipment that includes a printhead heat source for activating the color forming composition and forming the image.

Interest in linerless labels, which is a label that does not require a liner, has increased as a method of reducing cost and eliminating waste. Such labels are typically formed from rolls of label tape and include a release coating, which is provided to allow the label tape to be rolled onto itself and facilitate the unwinding of the roll by preventing adherence of the adhesive utilized to attach the label to objects after it has been formed. However, current linerless label tapes suffer from defects caused by excessive printhead debris, which causes surface scuffing, dusting, and other image defects on the label. A common cause of printhead debris are shortcomings of the release coating, which typically includes a UV cure system. Furthermore, current release coating materials have a short pot life, are difficult to apply, cure slowly or incompletely at temperatures of 80° C. or less, and do not exhibit good thermal stability once cured.

Therefore, it would be desirable to provide a release coating composition that can be utilized to overcome the aforementioned deficiencies and meet the performance criteria for use in linerless label applications.

### BRIEF SUMMARY

Embodiments of a release coating composition are provided. In an embodiment, the release coating composition comprises an organosilicon compound having at least one terminal aliphatically unsaturated group and an organosilicon composition. The organosilicon compound exhibits a viscosity of 150 cPs or less. The organosilicon composition exhibits a viscosity that is at least one hundred times the viscosity of the organosilicon compound. The release coating composition also comprises an organosilicon crosslinker having at least one Si-bonded hydrogen atom and a catalyst, which promotes the addition of the at least one Si-bonded hydrogen atom to the at least one aliphatically unsaturated group. One or more inhibitors are also included to retard the addition of the at least one Si-bonded hydrogen atom to the at least one aliphatically unsaturated group when the composition is at room temperature. Before curing, the release coating composition exhibits a viscosity of 150-800 cPs at 25° C. and the release coating composition cures at temperatures of 80° C. or less.

In an embodiment, the release coating composition comprises 50 wt % or more of the organosilicon compound, based on the total weight of the release coating composition, and the organosilicon compound exhibits a viscosity of 25 to 150 CPs at 25° C.

In other embodiments, the release coating composition comprises 30 wt % or less of the organosilicon composition, based on the total weight of the release coating composition. Preferably, the release coating composition comprises 5 to 20 wt % of the organosilicon composition, based on the total weight of the release coating composition.

In certain embodiments, the organosilicon composition has a viscosity of 5,000 to 15,000 cPs at 25° C. Preferably, the organosilicon composition has a viscosity of 8,000 to 11,000 cPs at 25° C.

In other embodiments, the organosilicon composition comprises a mixture of a first siloxane and a second siloxane. In one such embodiment, the first siloxane is an organopolysiloxane having a viscosity of 1000 cPs or less and at least one terminal aliphatically unsaturated group. In another embodiment, the second siloxane is an organopolysiloxane having a viscosity of 400,000 cPs or more and less than 1 functional group on average per molecule.

In an embodiment, the release coating composition comprises 150 ppm or less of the catalyst, based on the total weight of the release coating composition.

In another embodiment, the release coating composition comprises 1 wt % or less of the one or more inhibitors, based on the total weight of the release coating composition.

Preferably, the release coating composition is cured until it has 5 wt % or less of extractables, based on the total weight of the release coating composition.

Further, in some embodiments, the catalyst is a platinum complex containing at least one unsaturated group.

In some embodiments, a method for forming a coated article is provided. In one embodiment, the method comprises providing a substrate and applying the releasing coating composition over at least a portion of the substrate. The releasing coating composition is cured at a temperature of 80° C. or less.

In this embodiment, the release coating composition may be cured within 20 seconds.

### BRIEF DESCRIPTION OF THE SEVERAL VIEWS OF THE DRAWING

The above, as well as other advantages of the present invention will become readily apparent to those skilled in the art from the following detailed description when considered in the light of the accompanying drawings in which:

FIG. 1 is a graph of the cure speed, as measured by extractables over time, of an embodiment of the present invention and a comparative example.

### DETAILED DESCRIPTION

It is to be understood that the invention may assume various alternative orientations and step sequences, except where expressly specified to the contrary. It is also to be understood that the specific materials, compositions, articles, and methods described in the following specification are simply exemplary embodiments of the inventive concepts. Hence, specific properties, conditions, or other physical characteristics relating to the embodiments disclosed are not to be considered as limiting, unless expressly stated otherwise.

Further, as used herein, the terms “comprises,” “comprising,” “includes,” “including,” “has,” “having” or any other variation thereof, are intended to cover a non-exclusive inclusion. For example, a method, article, or composition that comprises a list of features is not necessarily limited only to those features but may include other features not expressly listed or inherent to such method, article, or composition. Further, unless expressly stated to the contrary, “or” refers to an inclusive- or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

In certain embodiments, a release coating composition is provided. The release coating composition is suitable for use in label making. For example, the release coating composition may be utilized to provide a non-tacky surface forming a portion of a label. Such labels may be used in so-called variable information printing applications and may have printing produced by way of thermal energy. Printing by way of thermal energy activates encapsulated ink within a paper substrate. Currently, labels that have printing produced via thermal energy are laminated to a siliconized paper or film liner, which serves only as a carrier and is thrown away after the label is dispensed. Advantageously, the release coating composition allows the thermally activatable label paper to be siliconized so that a film liner is not needed, which reduces cost and waste. This is not possible with current thermally curing silicone systems, as the activation temperature of the curing mechanism exceeds the activation temperature of the ink capsules in the paper, causing the label to turn black during application and curing of such silicone systems. However, the release coating composition is not limited to thermally activatable label paper applications and can be utilized in other applications where providing a non-tacky surface is desired. For example, the release coating composition may be utilized for the production of release, backing and interleaving papers, including interleaving and release papers. Additionally, the release coating composition is also suitable for the production of release, backing and interleaving cards, films and cloths, for treating the reverse sides of self-adhesive tapes or self-adhesive films or die written faces of self-adhesive labels. The release coating composition is also suitable for treating packaging material, such as paper, cardboard boxes, metal foils and drums, for example, cardboard, plastic, wood or iron, which is or are intended for the storage and/or transportation of tacky goods, such as adhesives, sticky foodstuffs, for example cakes, honey, candies and meat, bitumen, asphalt, greased materials and crude rubber. A further example of the use of the release coating composition is die treatment of supports for the transfer of contact adhesive layers in the so-called transfer process.

The release coating composition comprises an organosilicon compound. The organosilicon compound has at least one terminal aliphatically unsaturated group. Preferably, the aliphatic unsaturated group is an SiC-bonded group having an aliphatic carbon-carbon multiple bond.

The organosilicon compound may be linear or branched. In some embodiments, it may be preferred to use an organosilicon compound that is a linear or branched organopolysiloxane comprising units of the formula

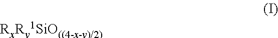

in which R is a monovalent hydrocarbon group which is free from aliphatic carbon-carbon multiple bonds and has 1 to 18 carbon atoms per group, and
R¹ is a monovalent hydrocarbon group with at least one terminal aliphatic carbon-carbon multiple bond, having 2 to 12 carbon atoms per group,
x is 0, 1, 2 or 3,
y is 0, 1 or 2
and the sum x+y is 0, 1, 2 or 3, with the proviso that on average there is at least 1 group R¹ per molecule, preferably at least 2 groups R¹ per molecule.

In certain embodiments, it may be preferred to use an organosilicon compound that is a linear organopolysiloxane of the formula

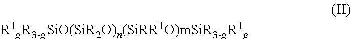

in which
R and R¹ have the meaning given above,
g is 0, 1 or 2,
n is 0 or an integer from 1 to 1500, and
m is 0 or an integer from 1 to 200,
with the proviso that there is at least one group R¹ per molecule, preferably at least 2 groups R¹ per molecule.

In formula (II), n units —(SiR₂O)— and m units —(SiRR₁O)— can be distributed in any desired fashion in the organopolysiloxane molecule.

In other embodiments, it may be preferred to use an organosilicon compound that is branched, such as branched siloxane copolymers which contain hydrocarbon blocks and siloxanes blocks. Examples of such branched siloxane copolymers are described in U.S. Pat. No. 7,888,446 B2 in col. 1, line 40 to col. 4, line 24, the entire disclosure of which is hereby incorporated by reference herein in its entirety.

In still other embodiments, it may be preferred to use an organosilicon compound that is a branched siloxane copolymers containing at least one structural unit of the general formula

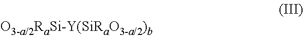

where
Y is a divalent to dodecavalent organic group, preferably di-, tri- or tetravalent organic group, more preferably a divalent organic group, wherein the organic group has 1 to 30 C atoms and may contain one or more O atoms,
a is 0 or 1, and
b is an integer from 1 to 11, preferably 1, 2 or 3, more preferably 1,
and at least one, preferably at least two, siloxane units of the formula

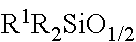

and optionally siloxanes units of the formula

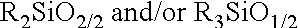

in which R and R¹ have the meaning given above.

Examples of hydrocarbon groups R are alkyl groups such as the methyl, ethyl, n-propyl, isopropyl, n-butyl, isobutyl, tert-butyl, n-pentyl, isopentyl, neopentyl and tert-pentyl groups; hexyl groups such as an n-heptyl group; octyl groups such as the n-octyl group and isooctyl groups such as the 2,2,4-trimethylpentyl group; nonyl groups such as the n-nonyl group; decyl groups such as the n-decyl group; dodecyl groups such as the n-dodecyl group; octadecyl groups, such as the n-octadecyl group; cycloalkyl groups such as cyclopentyl, cyclohexyl, cycloheptyl and methylcyclohexyl groups; aryl groups such as the phenyl, naphthyl, anthryl and phenanthryl groups; alkaryl groups such as the o-, m- and p-tolyl groups, xylyl groups and ethylphenyl groups; and aralkyl groups such as the benzyl group, and the α- and the β-phenylethyl groups.

Examples of groups R¹ are alkenyl groups such as the vinyl, 5-hexenyl, 2,4-divinylcyclohexylethyl, 3,4-divinylcyclohexylethyl, 2-propenyl, allyl, 3-butenyl and 4-pentenyl groups, and alkynyl groups such as the ethynyl, propargyl and 2-propynyl groups. In certain embodiments, it may be preferred that R¹ is a vinyl group. When R¹ is a vinyl group, the designation “Vi” may be utilized herein.

In some embodiments, the release coating composition comprises 50 wt % or more of the organosilicon compound, based on the total weight of the release coating composition. In one such embodiment, the release coating composition comprises 50 to 90 wt % of the organosilicon compound, based on the total weight of the release coating composition. In other embodiments, the release coating composition comprises 60 wt % or more of the organosilicon compound, based on the total weight of the release coating composition. In one such embodiment, the release coating composition comprises 60 to 85 wt % of the organosilicon compound, based on the total weight of the release coating composition. In still other embodiments, the release coating composition comprises 70 to 85 wt % of the organosilicon compound, based on the total weight of the release coating composition.

The organosilicon compound exhibits a viscosity of 150 cPs or less at 25° C., preferably from 25 to 150 cPs at 25° C., and more preferably from 50 to 125 cPs at 25° C. The viscosity of the organosilicon compound can be determined by measurement using rotational viscometry in accordance with DIN EN ISO 3219.

In some embodiments, the organosilicon compound may be provided as all or a portion of a component (A). In certain embodiments, component (A) may comprise a mixture of organopolysiloxanes including one or more embodiments of the organosilicon compound described above. Additional organopolysiloxanes may also be suitable for use in component (A).

The release coating composition also comprises an organosilicon composition. The organosilicon composition is provided to increase the suitability of the release coating composition in a thermally activatable label system. More particularly, the organosilicon composition reduces the friction between the cured release coating composition and the thermal printhead device, which helps to reduce printhead debris during printing.

The organosilicon composition may be provided as a portion of a component (A). The organosilicon composition exhibits a viscosity that is at least one hundred times the viscosity of the organosilicon compound. In certain embodiments, the organosilicon composition has a viscosity of 5,000 to 15,000 cPs at 25° C. In other embodiments, the organosilicon composition has a viscosity of 8,000 to 11,000 cPs at 25° C. The viscosity of the organosilicon composition can be determined by measurement using rotational viscometry in accordance with DIN EN ISO 3219.

Preferably, the organosilicon composition comprises a mixture of a first siloxane and a second siloxane.

In an embodiment, the first siloxane is an organopolysiloxane having a viscosity of 1000 cPs or less at 25° C. Preferably, the first siloxane is an organopolysiloxane having a viscosity of 25 to 500 cPs at 25° C. More preferably, the first siloxane is an organopolysiloxane having a viscosity of 50 to 300 cPs at 25° C. The viscosity of the first siloxane can be determined by measurement using rotational viscometry in accordance with DIN EN ISO 3219.

The organosilicon composition may be generally non-functional. However, the first siloxane may be an organopolysiloxane having at least one terminal aliphatically unsaturated group. Preferably, the first siloxane has two terminal aliphatic unsaturated groups. In certain embodiments, each terminal aliphatic unsaturated group is an SiC-bonded group having an aliphatic carbon-carbon multiple bond such as a vinyl bond. In some embodiments, the first siloxane is a vinyl-functional, substantially linear organopolysiloxane. Particularly preferred are organopolysiloxanes of the formula

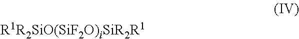

in which
j is an integer from 60 to 120, and
R and R¹ have the meaning given above.

The second siloxane is an organopolysiloxane having a viscosity of 400,000 cPs or more. Preferably, the second siloxane has a viscosity of 800,000 cPs or more. In some embodiments, the second siloxane may have a viscosity of 1,000,000 cPs or more. The viscosity of the second siloxane can be determined by measurement using rotational viscometry in accordance with DIN EN ISO 3219.

The second siloxane may have a very high molecular weight. For example, the second siloxane may have a molecular weight of 650,000 mm²/s or more, preferably of 850,000 mm²/s, even more preferably of 1,000,000 mm²/s or more. The upper molecular weight limit for the second siloxane is limited by the impact on the viscosity of the release coating composition. It is desirable that the extractables of the second siloxane are low. Thus, in some embodiments, the second siloxane has less than 1 functional group on average per molecule. In other embodiments, the second siloxane has less than 0.5 functional groups on average per molecule. In still other embodiments, the second siloxane may have no functional groups on average per molecule.

Preferred for the second siloxane are organopolysiloxanes of the formula

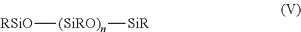

where R has the meaning given earlier, but is preferably the methyl group and n is selected such as to give the desired molecular weight and viscosity. The second siloxane may also be lightly crosslinked, for example containing up to 5 mol percent of RSiO_{3/2} and SiO_{4/2} groups, with R preferably being a methyl group, based on the total moles of the siloxy groups.

The organosilicon composition may comprise 20 wt % or more of the first siloxane, with the balance being primarily made up by the second siloxane. In an embodiment, the organosilicon composition comprises 20 to 98 wt % of the first siloxane, with the balance being primarily made up by the second siloxane. In another embodiment, the organosilicon composition comprises 50 to 90 wt % of the first siloxane, with the balance being primarily made up by the second siloxane. In still another embodiment, the organosilicon composition comprises 60 to 80 wt % of the first siloxane, with the balance being primarily made up by the second siloxane. In these embodiments, wt % is based on the total weight of the organosilicon composition.

Preferably, the release coating composition comprises 50 wt % or less of the organosilicon composition. In an embodiment, the release coating composition comprises 5 to 50 wt % of the organosilicon composition. More preferably, the release coating composition comprise 30 wt % or less of the organosilicon composition. In one such embodiment, the release coating composition comprises 5 to 30 wt % of the organosilicon composition. In another embodiment, the release coating composition comprises 5 to 20 wt % of the organosilicon composition. In these embodiments, wt % is based on the total weight of the release coating composition.

The release coating composition also comprises an organosilicon crosslinker having at least one Si-bonded hydrogen atom. A Si-bonded hydrogen atom may also be referred to herein by using the designation “SiH.” The organosilicon crosslinker may be linear, cyclic or a branched organopolysiloxane comprising units of the formula

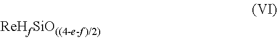

in which R has the meaning given above,
e is 0, 1, 2 or 3,
f is 0, 1 or 2
and the sum of e+f is 0, 1, 2 or 3,
with the proviso that on average there is at least 1 Si-bonded hydrogen atom per molecule, preferably there are at least 2 Si-bonded hydrogen atoms per molecule.

Preferably, the organosilicon crosslinker is an organopolysiloxane of the formula

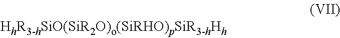

in which
R has the meaning given above,
h is 0, 1 or 2,
is 0 or an integer from 1 to 1500, and
p is 0 or an integer from 1 to 200,
with the proviso that there is at least 1 Si-bonded hydrogen atom per molecule, preferably there is at least 2 Si-bonded hydrogen atoms per molecule.

In formula (VII) it is understood that o units —(SiR₂O)— and p units —(SiRHO)— can be distributed in any desired fashion in the organopolysiloxane molecule.

The organosilicon crosslinker contains at least 0.04% by weight (wt %), preferably from 0.8 to 1.7 wt %, Si-bonded hydrogen, based on the total weight of the organosilicon crosslinker. The organosilicon crosslinker possess an average viscosity of from 10 to 1000 cPs at 25° C., preferably from 10 to 100 cPs at 25° C. The viscosity of the organosilicon crosslinker is determined by measurement using rotational viscometry in accordance with DIN EN ISO 3219.

The organosilicon crosslinker is employed such that the molar ratio of SiH groups to aliphatically unsaturated groups in the composition is 0.8 to 10.0, preferably from 1.0 to 5, and more preferably 1.5 to 3.

The release coating composition comprises a catalyst. In some embodiments, the release coating composition comprises 300 parts per million (ppm) or less catalyst, based on the total weight of the release coating composition. For example, the release coating composition may comprise 50 to 300 ppm catalyst, based on the total weight of the release coating composition. Preferably, the release coating composition comprises 250 ppm or less catalyst, based on the total weight of the release coating composition. In one such embodiment, the release coating composition may comprise 50 to 250 ppm catalyst, based on the total weight of the release coating composition. Advantageously, the release coating composition is formed so that it can cure at low temperatures of, for example, 80° C. or less with a catalyst concentration of 200 ppm or less. Thus, in some embodiments, the release coating composition comprises 200 ppm or less catalyst, based on the total weight of the release coating composition. In other embodiments, the release coating composition comprises 150 ppm or less catalyst, based on the total weight of the release coating composition. For example, in an embodiment, the concentration of catalyst for catalyzing curing may be in an amount between 50 and 150 ppm, 75 and 150 ppm, or 100 and 150 ppm of the catalyst, depending on the total weight of the release coating composition.

The catalyst promotes the addition of a Si-bonded hydrogen atom from the organosilicon crosslinker to an aliphatically unsaturated group of the organosilicon compound. Preferably, the catalyst is of the hydrosilyation variety, which is understood as meaning a catalyst which promotes the addition of Si-bonded hydrogen onto an aliphatic multiple bond.

Hydrosilylation catalysts known in the art are suitable for use in the release coating composition. When the catalyst is of the hydrosilyation variety, the catalyst typically will comprise platinum, but other platinum-group metals such as, for example, rhodium may be utilized. In an embodiment, the catalyst may include metallic and finely divided platinum which can be present on supports such as silicon dioxide, aluminum oxide or activated carbon. In other embodiments, the catalyst may be a compound or complex of platinum. For example, suitable compounds and complexes include platinum halides, e.g. PtCl₄, H₂PtCl₆·6H₂O, Na₂PtCl₄·4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₆·6H₂O and cyclohexanone, platinum-vinylsiloxane complexes, in particular platinum-divinyltetramethyldisiloxane complexes with or without detectable inorganically bound halogen, bis(gamma-picoline) platinum dichloride, trimethylenedipyridineplatinum dichloride, dicyclopentadieneplatinum dichloride, (dimethyl sulfoxide)ethyleneplatinum(II) dichloride and also reaction products of platinum tetrachloride with olefin(s) and primary amine or secondary amine, or primary and secondary amine, for example the reaction product of platinum tetrachloride dissolved in 1-octene with sec-butylamine, or ammonium-platinum complexes.

Preferably, the catalyst is a platinum complex comprising at least one unsaturated group. In such an embodiment, the catalyst may be the so-called Karstedt catalyst, i.e. a Pt(0) complex, in particular the platinum(0)-1,3-divinyl-1,1,3,3-tetramethyldisiloxane complex of the formula Pt₂[[(CH₂═CH)(CH₃)₂Si]₂O]₃.

When the composition is formed by mixing a component A and a component B, the two components may comprise all constituents referred to above in any desired combinations, generally with the proviso that one component does not simultaneously comprise organosilicon compound, organosilicon crosslinker, and the hydrosilylation catalyst. Thus, in the case of a two-component composition, the hydrosilyation catalyst is preferably provided as a portion of component (A) or component (B).

Further, the release coating composition also comprises one or more inhibitors. In certain embodiments, it may be preferred to include an inhibitor that is acceptable for contact with foodstuffs. In some embodiments, the curable composition may comprise a hydrosilylation inhibitor, which is understood to mean an agent that retards the addition of Si-bonded hydrogen onto an aliphatic multiple bond at room temperature, but does not retard curing at elevated temperatures. Inhibitors of this kind are heat-deactivatable inhibitors or are sufficiently volatile to be expelled from the release coating composition at elevated temperature. Such inhibitors are utilized so that the release coating composition exhibits a predetermined processing life and curing onset temperature.

Examples of suitable inhibitors are acetylenic alcohols, such as 1-ethynyl-1-cyclohexanol, 2-methyl-3-butyn-2-ol, and 3,5-dimethyl-1-hexyn-3-ol, 3-methyl-1-dodecyn-3-ol, polymethylvinylcyclosiloxanes such as 1,3,5,7-tetravinyltetramethyltetracyclosiloxane, low molecular mass silicone oils with methylvinyl-SiO_{1/2} groups and/or R₂vinylSiO_{1/2} end groups, such as divinyltetramethyldisiloxane, tetravinyldimethyldisiloxane, trialkyl cyanurates, alkyl maleates, such as diallyl maleates, dimethyl maleate, and diethyl maleate, alkyl fumarates, such as diallyl fumarate and diethyl fumarate, organic hydroperoxides such as cumene hydroperoxide, tert-butyl hydroperoxide, and pinane hydroperoxide, organic peroxides, organic sulfoxides, organic amines, diamines and amides, phosphanes and phosphites, nitriles, triazoles, diaziridines, and oximes. In certain embodiments, the one or more inhibitors are provided in the release coating composition in an amount of 5 wt % or less, based on the total weight of the release coating composition. In one such embodiment, the one or more inhibitors may be provided in the release coating composition in a quantitative fraction of 0.00001 to 5 wt %, based on the total weight of the release coating composition. Preferably, the one or more inhibitors are provided in the release coating composition in an amount of 0.00005 to 2 wt %, which is based on the total weight of the composition. In another embodiment, the one or more inhibitors are provided in the release coating composition in an amount of 1 wt % or less, based on the total weight of the release coating composition. In this embodiment, the one or more inhibitors may be provided in the release coating composition at 0.0001 to 1 wt %, which in each case is based on the total weight of the composition.

Preferred inhibitors are of the formula (VIII)

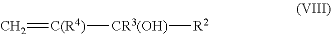

wherein
R² is a hydrogen atom or a monovalent hydrocarbon group having 1 to 12 carbon atoms optionally substituted with one or more hydroxyl groups,
with the proviso that R² is not a hydrogen atom if R³ and R⁴ are both a hydrogen atom,
R³ is a hydrogen atom or a monovalent hydrocarbon group having 1 to 12 carbon atoms or R³ forms together with R² a cyclic hydrocarbon group having 1 to 12 carbon atoms, and
R⁴ is a hydrogen atom or a monovalent hydrocarbon group having 1 to 12 carbon atoms.

Examples of groups R², R³ and R⁴ are alkyl groups such as the methyl, ethyl, n-propyl, isopropyl, 1-n-butyl, 2-n-butyl, isobutyl, tert-butyl, n-pentyl, isopentyl, neopentyl, and tert-pentyl groups; hexyl groups such as the n-hexyl group; heptyl groups such as the n-heptyl group; octyl groups such as the n-octyl group and isooctyl groups such as the 2,2,4-trimethylpentyl group, nonyl groups such as the n-nonyl group; decyl groups such as the n-decyl group; dodecyl groups such as the n-dodecyl group; cycloalkyl groups, such as cyclopentyl, cyclohexyl, cycloheptyl and methyl-cyclohexyl groups; aryl groups such as the phenyl group; alkaryl groups such as the o-, m-, p-tolyl groups, xylyl groups and ethylphenyl groups; and aralkyl groups, such as the benzyl group and the α- and β-phenylethyl groups.

The group R² can also be an alkenyl group such as the vinyl group or a group of the formula —CH₂CH₂CH═CH(CH₃)₂ (4,4-dimethyl-3-butenyl).

A preferred inhibitor according to formula (VIII) is
linalool, a compound of the formula

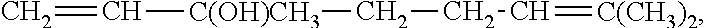

1-dodecen-3-ol,
1-decen-3-ol,
1-penten-3-ol,
1-hexen-3-ol,
1-hepten-3-ol,
1,4-pentadien-3-ol
2-methyl-2-propen-1-ol,
3-methyl-5-hexen-3-ol,
1-vinyl-cyclohexanol,
3-methyl-1-penten-3-ol,
2-methyl-1-hepten-3-ol and
2-methyl-3-buten-2-ol.

Linalool can be used alone or in combination with other additional inhibitors such as acetylinic alcohols. Examples for acetylinic alcohols are
1-ethynylcyclohexan-1-ol (ECH),
2-methyl-3-butyn-2-ol (MB),
3-methyl-I-pentyn-3-ol,
2,5-dimethyl-3-hexyne-2,5-diol
3,5-dimethyl-1-hexyn-3-ol and
3,7-dimethyl-oct-1-yn-6-en-3-ol.

Preferred examples for acetylinic alcohols are
1-ethynylcyclohexan-1-ol (ECH) and
2-methyl-3-butyn-2-ol (MB).

In certain embodiments, the preferred inhibitors are MB and linalool. MB and linalool are available from BASF Corporation In certain embodiments, using MB and linalool in combination is preferred. Surprisingly, it has been discovered that in such embodiments the pot life of the release coating composition can be extended and the release coating composition can be cured, the extractables can be reduced, and the release coating composition can be cured at a low temperature such as, for example, at 80° C. or less. In these embodiments, it may be preferred that the amount of linalool provided is greater than the amount of MB provided.

Further, the release coating composition may comprise additional additives such, for example, fillers, pigments, and/or dyes.

In some embodiments, the release coating composition comprises fillers, in amounts of up to 50% by weight of total weight of the release coating composition, more preferably, in increasing order of preference, up to 40% by weight, 30% by weight, and 10% by weigh. In certain embodiments, fillers are absent, or are contained in amounts of less than 10% by weight, more preferably less than 5% by weight. Fillers may be added to alter the viscosity of the uncured release coating composition, to alter its rheological profile (e.g. thixotropy, dilatency), to improve anchorage, or to alter release properties such as release force. The latter are most influenced by non-reinforcing fillers, whereas the former are most influenced by reinforcing fillers.

Both reinforcing and non-reinforcing fillers may be composed of the same materials, examples of which are silica, alumina, titania, and mixtures thereof, iron oxides, talc, mica, carbon, etc. Reinforcing fillers have BET surface areas greater than 50 m²/g, more preferably greater than 100 m²/g, and yet more preferably about 200 m²/g or more. Non-reinforcing fillers have BET surface areas of less than 50 m²/g. Preferred examples of reinforcing fillers are fumed and colloidal silicas having surface areas greater than 50 m²/g, preferably greater than 100 m²/g, and most preferably in the range of 200-300 m²/g. Preferred non-reinforcing fillers include ground minerals such as, for example, quartz, limestone, marble, dolomite, clay minerals, and talc. Both types of fillers may be used in their natural state, which is generally somewhat hydrophilic, or may be hydrophobicized by techniques well known to those skilled in the art, for example by coating with wax, metal stearates, silicone fluids, etc., or by reactively coating with reactive silicones, for example, those containing silicon-bonded alkoxy groups, or with reactive silanes such as, for example, alkylchlorosilanes, alkylalkoxysilanes, and hexamethyldisilizane. The modification of the fillers may take place externally, as is often the case, or the modification may take place in situ. Processes known in the art for making such modifications are suitable for use.

Pigments may be employed to alter the color of the resulting release coating, which, in the absence of fillers, are generally colorless and transparent. Once fillers are present, depending upon the amount and particle size of the fillers, the compositions may range from transparent through translucent, to opaque. In general, one skilled in the art of silicone release coatings does not consider conventional fillers such as those of silica, alumina, or titanium, to be pigments, since they do not provide any color to the composition, and may even produce transparent compositions. Typical pigments include organic pigments and inorganic pigments such as the various iron oxide pigments, carbon blacks, etc. Suitable dyes include both natural and synthetic varieties. Preferably, the release coating composition contains 5 wt %, based on the total weight of the release coating, or less of dyes and/or pigments in total, more preferably less than 3 wt %, and most preferably less than 2 wt %. However, in certain embodiments, it may be preferred that no dyes and/or pigments are present.

In advance of forming the release coating composition, the composition may be made by preparing component (A). Preferably, component (A) comprises the organosilicon compound, the organosilicon composition, and one or more inhibitors. When included in component (A), the organosilicon composition and the one or more inhibitors may be mixed with the organosilicon compound to form a mixture. Mixing can be done at a predetermined rate, for a predetermined period of time, and utilizing commercially available mixing devices such as, for example, a Speedmixer® or a Dispermat® fitted with a dissolver blade. The organosilicon compound, the organosilicon composition, and one or more inhibitors may be as described above. Further, component (A) may be formed by including one or more of the additives mentioned above.

In certain embodiments, the curable composition may be made by preparing component (B). Preferably, component (B) may comprise the organosilicon compound. Additionally, component (B) may comprise one or more inhibitors, an organosilicon crosslinker, and a catalyst. When included in component (B), the one or more inhibitors, organosilicon crosslinker, and catalyst may be mixed with the organosilicon compound to form a mixture. Mixing can be done at a predetermined rate, for a predetermined period of time, and utilizing commercially available mixing devices such as, for example, the mixing devices mentioned above. The organosilicon compound, the one or more inhibitors, organosilicon crosslinker, and catalyst may be as described above. Further, component (B) may be formed by including one or more of the additives mentioned above.

The release coating composition may be formed by mixing. In certain embodiments, and prior to coating the substrate, component (A) and component (B) may be mixed to form the release coating composition. Mixing can be done at a predetermined rate, for a predetermined period of time, and in a conventional manner such as by utilizing commercially available mixing devices such as, for example, the mixing devices mentioned above.

After mixing and prior to curing, the release coating composition exhibits a desirable pot life. For example, at a catalyst concentration of 150 ppm or less, the release coating composition may exhibit a pot life of 8 hours of more. At higher catalyst concentrations such as, for example, a concentration of 200 ppm, the release coating composition may exhibit a pot life of 6 hours of more.

After being formed and before being cured, the release coating composition preferably exhibits a desirable viscosity. The viscosity is selected so that the release coating composition can be applied to a substrate without the need for specialized coating equipment. In an embodiment, the release coating composition exhibits a viscosity of 100-800 cPs at 25° C. More preferably, the release coating composition exhibits a viscosity of 100-300 cPs at 25° C. Even more preferably, the release coating composition exhibits a viscosity of 120-300 cPs at 25° C. The viscosity can be determined by measurement using rotational viscometry in accordance with DIN EN ISO 3219.

The desirable viscosity exhibited by the release coating composition enables the composition to be formed without the need for a solvent. Thus, in certain embodiments, the release coating composition is solventless, i.e. does not include a solvent. For example, the release coating composition may not include solvents such as, for example, organic solvents such as toluene or inorganic solvents such as water. In the latter embodiment, the release coating composition is said to be non-aqueous. Eliminating the use of a solvent reduces the cost of the composition, helps to avoid damage to the substrate during application of the release coating composition and further processing, and allows the composition to be applied to the substrate using convention coating equipment, which further reduces costs.

After forming the release coating composition, a surface of a substrate can be coated with the release coating composition. Suitable substrate surfaces can be of any desired materials which are solid at room temperature and 1013.25 hPa. The substrate can be a single layer of material or comprises several layers. Suitable materials include and the surface can be defined by paper, wood, cork and plastic films, for example polyethylene films or polypropylene films, woven and nonwoven fabric of natural or synthetic fibers or glass fibers, ceramic articles, glass, metals, polyethylene-coated paper, and cards and boards, including those of asbestos. The abovementioned polyethylene can comprise high-pressure, medium-pressure or low-pressure polyethylene. The paper can comprise low-grade paper types, such as absorbent papers, including raw kraft paper, i.e. kraft paper which has not been pretreated with chemicals and/or polymeric natural substances, having a weight of from 60 to 150 g/m², unsized papers, papers of low freeness value, mechanical papers, unglazed or uncalendered papers, papers which are smooth on one side owing to the use of a dry glazing cylinder during their production, without additional complex measures, and are therefore referred to as “machine-glazed papers”, uncoated papers or papers produced from waste paper, i.e. recycled papers. The paper to be treated in accordance with the invention may also comprise high-grade papers, such as low-absorbency papers, sized papers, papers of high freeness value, chemical papers, calendered or glazed papers, glassine papers, parchmentized papers or precoated papers. The cards and boards may also be of low or high grade. Preferably, in a linerless label application, the substrate is part of a system that includes one or more color forming materials that upon heating provide a thermal response and produce an image.

The release coating composition can be applied to the substrate to provide any desired thickness, pattern, or morphology. The application of the release coating composition to a surface of the substrate can be accomplished by known methods for applying coatings from liquid substances. Suitable methods include dipping, brushing, pouring, spraying, rolling, printing, for example by an offset gravure coating device, by knife-coating or by means of an airbrush. Particularly suitable for applying the composition is a multi-roll system (4-6 rolls), such as rubber-steel-rubber in which die film is divided so often that finally an application of 0.1 to 2 μm is obtained.

The release coating composition can be applied to the substrate by the methods mentioned above to form, for example, a linerless label roll. In some embodiments, the release coating composition can be applied to a surface of the substrate while the substrate is moving. In on such embodiment, the substrate may be moving at a rate of from 50 to 500 m/min, preferably from 100 to 300 m/min.

After applying the release coating composition to a substrate, the release coating composition can be cured. The composition can be cured at a predetermined temperature and for a predetermined period of time.

Preferably, the release coating composition is an addition curing system. In the context of the describing the release coating composition, the release coating composition is “cured” when until it has 5 wt % or less of extractables, based on the total weight of the release coating composition. The wt % of extractables can be measured by coating a substrate with the coating composition and placing the coated substrate in toluene for 24 hours. Then, the concentration of silicone oil in the toluene is measured with atomic absorption. The result is expressed as the percentage of silicone coating that is extracted by the toluene (dry weight/dry weight).

The release coating composition can be cured at the pressure of the surrounding atmosphere, i.e. at about 1013.25 hPa, but can also be cured at higher or lower pressures. The release coating composition can be cured at a predetermined temperature or within a predetermined temperature range. For example, when using the release coating composition over a thermally activatable label paper, the composition can be cured at a temperature of 80° C. or less, which is under the activation temperatures of the ink capsules in the paper so that the ink capsules remain unchanged. In such an embodiment, the curing may be at a temperature of 40° C. to 80° C., more preferably 60° C. to 80° C. It is preferred to use an oven, for example, a convection oven, heating tunnel, heated rolls, heated plate or heat rays in the infrared range to achieve the aforementioned curing temperatures.

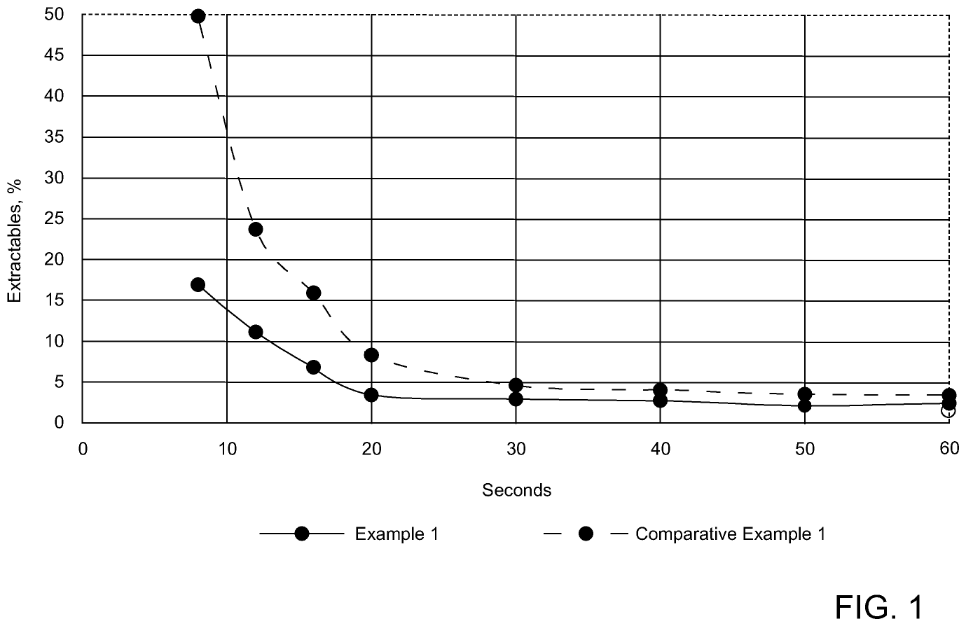

Another advantage of the release coating composition is that it cures at the temperatures described above at a faster rate or cures at a similar rate using less catalyst than the known compositions for such release coatings. For example, and as illustrated in FIG. 1, in certain embodiments, the release coating composition is cured within 20 seconds with a catalyst concentration of 150 ppm or less.

In a linerless label application, the method of forming the linerless label may also include applying an adhesive to another surface of the substrate, which is opposite the surface that the release coating composition is applied to and cured on. In this embodiment, it is preferred that the release coating composition is separated from an outer adhesive layer by the substrate. In this position, the cured release coating composition may define a first major outer surface and the outer adhesive layer may define a second major outer surface. The resulting composite can then be wound upon itself without the use of a liner.

### EXAMPLES

The following examples are presented solely for the purpose of further illustrating and disclosing the embodiments of the release coating composition. An example of the release coating composition is described below in Example 1. Comparative Example 1, which is not part of the invention, is also described below.

### Example 1

A linear organosilicon compound sold under the tradename Vipo 50 and available from Wacker Chemical Corporation was mixed with an organosilicon composition. The organosilicon compound exhibited a viscosity of approximately 50 cPs at 25° C. The organosilicon composition exhibited a viscosity of approximately 8000 cPs at 25° C. and comprised a mixture of a first siloxane and a second siloxane. The first siloxane was an organopolysiloxane having a viscosity of less than 1000 cPs and at least one terminal aliphatically unsaturated group and the second siloxane was an organopolysiloxane having a viscosity of more than 400,000 cPs and less than 1 functional group on average per molecule. The organosilicon compound and the organosilicon composition were mixed to form a mixture comprising 79.6 wt % of the organosilicon compound and 19.8 wt % of the organosilicon composition, based on the total weight of the mixture. The balance of the mixture included an inhibitor system comprising a blend of linalool and 2-methyl-3-butyn-2-ol. To form the mixture, the organosilicon compound and the organosilicon composition were added to a container and stirred for one minute and then the inhibitor system was added and stirred in for one minute.

Next, the release coating composition of Example 1 was formed. The release coating composition comprised 74.9 wt % of the mixture described above, 12.0 wt % of an organosilicon crosslinker, and 13.1 wt % catalyst. To form the release coating composition, a portion of the mixture was mixed with an organosilicon crosslinker, which was added and stirred in with the mixture for one minute. The crosslinker is available under the tradename V88 from Wacker Chemical Corporation and had at least one SiH group. The organosilicon crosslinker was added in an amount to the mixture so that the molar ratio of SiH groups to vinyl groups in the release coating composition was 2.5. The catalyst was of the hydrosilylation variety, like those described above, and available under the tradename C05 from Wacker Chemical Corporation. The catalyst was added after adding the organosilicon crosslinker and stirred in for one minute to form the release coating composition. The catalyst was added in an amount so that the release coating composition included 150 ppm of the catalyst, based on the total weight of the release coating composition.

The release coating composition of Example 1 exhibited a viscosity of 161 cPs at 25° C., which was measured using rotational viscometry in accordance with DIN EN ISO 3219.

### Comparative Example 1

A branched organosilicon compound was mixed with an organosilicon composition. The organosilicon compound of Comparative Example 1 exhibited a viscosity of 280 cPs at 25° C. The organosilicon composition exhibited a viscosity of approximately 8000 cPs at 25° C. and comprised a mixture of a first siloxane and a second siloxane. The first siloxane was an organopolysiloxane having a viscosity of less than 1000 cPs and at least one terminal aliphatically unsaturated group and the second siloxane was an organopolysiloxane having a viscosity of more than 400,000 cPs and less than 1 functional group on average per molecule. The organosilicon compound and the organosilicon composition were mixed to form a mixture comprising 79.6 wt % of the organosilicon compound and 19.8 wt % of the organosilicon composition, based on the total weight of the mixture. The balance of the mixture included an inhibitor system comprising a blend of linalool and 2-methyl-3-butyn-2-ol. To form the mixture, the organosilicon compound and the organosilicon composition were added to a container and stirred for one minute and then the inhibitor system was added and stirred in for one minute.

Next, the coating composition of Comparative Example 1 was formed. The coating composition comprised 74.9 wt % of the mixture described above, 12.0 wt % of an organosilicon crosslinker, and 13.1 wt % catalyst. To form the coating composition, a portion of the mixture was mixed with an organosilicon crosslinker, which was added and stirred in with the mixture for one minute. The crosslinker is available under the tradename V88 from Wacker Chemical Corporation and had at least one SiH group. The organosilicon crosslinker was added in an amount to the mixture so that the molar ratio of SiH groups to vinyl groups in the coating composition was 2.5. The catalyst was of the hydrosilyation variety, like those described above, and available under the tradename C05 from Wacker Chemical Corporation. The catalyst was added after adding the organosilicon crosslinker and stirred in for one minute to form the coating composition. The catalyst was added in an amount so that the coating composition included 150 ppm of the catalyst, based on the total weight of the coating composition.

The coating composition of Comparative Example 1 exhibited a viscosity of 161 cPs at 25° C., which was measured using rotational viscometry in accordance with DIN EN ISO 3219.

5 mL samples of the release coating composition of Example 1 and the coating composition of Comparative Example 1 were applied to supercalendered kraft paper substrates using a single sheet blade coater at 40 psi. Each coated substrate was placed in an oven. The oven was at 80° C. when the samples were placed inside. After a respective predetermined period of time, each sample was removed from the oven and the extractable silicone content (extractables) of the coated substrates was determined. For each sample, which are individually represented by the data points on the graph of FIG. 1, the wt % of the extractables was measured by placing the coated substrate in toluene for 24 hours. Then, the concentration of silicone oil in the toluene is measured with atomic absorption spectroscopy using a Perkin Elmer PinAAcle 500 spectrometer. The result is expressed as the percentage of silicone coating that is extracted by the toluene (dry weight/dry weight). The percentage corresponds to the curing of the respective samples. A composition is not “cured” until it has only 5 wt % or less of extractables, based on the total weight of the composition.

The results for the release coating composition of Example 1 and the coating composition of Comparative Example 1 are shown in FIG. 1. As illustrated, the release coating composition was able to cure in 20 seconds or less. More particularly, the release coating composition of Example 1 was cured in 18 seconds. In stark contrast, the coating composition of Comparative Example 1 was not cured until it was in the oven for 28 seconds. Thus, the cure of the release coating composition of Example 1 was 35% faster than that of the coating composition of Comparative Example 1.

From the foregoing detailed description, it will be apparent that various modifications, additions, and other alternative embodiments are possible without departing from the true scope and spirit. The embodiments and examples discussed herein were chosen and described to provide the best illustration of the principles of the invention and its practical application to thereby enable one of ordinary skill in the art to use the invention in various embodiments and with various modifications as are suited to the particular use contemplated. As should be appreciated, all such modifications and variations are within the scope of the invention.

1-15. (canceled)

16. A release coating composition, comprising:
(a) an organosilicon compound having at least one terminal aliphatically unsaturated group, the organosilicon compound exhibiting a viscosity of 150 cPs or less which is determined by rotational viscometry in accordance with DIN EN ISO 3219;
(b) an organosilicon composition comprising a mixture of a first siloxane and a second siloxane, the second siloxane having no functional groups and being an organopolysiloxane of the formula (V): 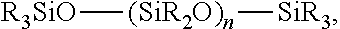
where R is a methyl group,
n is selected such as to give the desired viscosity,
wherein the organosilicon composition exhibits a viscosity that is at least one hundred times the viscosity of the organosilicon compound;
(c) an organosilicon crosslinker having at least one Si-bonded hydrogen atom;
(d) a catalyst which promotes the addition of the at least one Si-bonded hydrogen atom to the at least one aliphatically unsaturated group; and
(e) one or more inhibitors that retard the addition of the at least one Si-bonded hydrogen atom to the at least one aliphatically unsaturated group when the composition is at room temperature,
wherein, before curing, the release coating composition exhibits a viscosity of 100-800 cPs at 25° C., which is determined by rotational viscometry in accordance with DIN EN ISO 3219 and the release coating composition cures at temperatures of 80° C. or less.

17. The release coating composition of claim 16, wherein the release coating composition comprises 50 wt % or more of the organosilicon compound, based on the total weight of the release coating composition, and the organosilicon compound exhibits a viscosity of 25 to 150 CPs at 25° C., which is determined by rotational viscometry in accordance with DIN EN ISO 3219.

18. The release coating composition of claim 16, wherein the release coating composition comprises 30 wt % or less of the organosilicon composition, based on the total weight of the release coating composition.

19. The release coating composition of claim 16, wherein the organosilicon composition has a viscosity of 5,000 to 15,000 cPs at 25° C., which is determined by rotational viscometry in accordance with DIN EN ISO 3219.

20. The release coating composition of claim 16, wherein the release coating composition comprises 150 ppm or less of the catalyst, based on the total weight of the release coating composition.

21. The release coating composition of claim 16, wherein the release coating composition comprises 1 wt % or less of the one or more inhibitors, based on the total weight of the release coating composition.

22. The release coating composition of claim 16, wherein the release coating composition is cured until it has 5 wt % or less of extractables, based on the total weight of the release coating composition, which is measured by coating a substrate with the coating composition, placing the coated substrate in toluene for 24 hours, and measuring the concentration of silicone oil in the toluene with atomic absorption.

23. The release coating composition of claim 18, wherein the release coating composition comprises 5 to 20 wt % of the organosilicon composition, based on the total weight of the release coating composition.

24. The release coating composition of claim 19, wherein the organosilicon composition has a viscosity of 8,000 to 11,000 cPs at 25° C., which is determined by rotational viscometry in accordance with DIN EN ISO 3219.

25. The release coating composition of claim 16, wherein the first siloxane is an organopolysiloxane having a viscosity of 1000 cPs or less, which is determined by rotational viscometry in accordance with DIN EN ISO 3219, and at least one terminal aliphatically unsaturated group.

26. The release coating composition of claim 16, wherein the second siloxane is an organopolysiloxane having a viscosity of 400,000 cPs or more, which is determined by rotational viscometry in accordance with DIN EN ISO 3219.

27. The release coating composition of claim 16, wherein the catalyst is a platinum complex containing at least one unsaturated group.

28. A method of forming a coated article, comprising:
providing a substrate; and
applying the releasing coating composition of claim 1 over at least a portion of the substrate; and
curing the releasing coating composition at a temperature of 80° C. or less.

29. The method of claim 11, wherein the release coating composition of claim 16 is cured within 20 seconds.
